(19) United States
(12) Patent Application Publication
(10) Pub. No.: US 2013/0024389 A1
(43) Pub. Date: Jan. 24, 2013

(54) METHOD AND APPARATUS FOR EXTRACTING BUSINESS-CENTRIC INFORMATION FROM A SOCIAL MEDIA OUTLET

(71) Applicant: NARENDRA GUPTA, Dayton, NJ (US)

(72) Inventor: NARENDRA GUPTA, Dayton, NJ (US)

(21) Appl. No.: 13/186,062

(22) Filed: Jul. 19, 2011

(51) Int. Cl. G06Q 99/00

(52) U.S. Cl. 705/319

(57) ABSTRACT

A method, non-transitory computer readable medium and apparatus for extracting business centric information from a social media outlet are disclosed. For example, the method obtains a plurality of messages from a social media outlet, classifies a subset of the plurality of messages obtained from the social media outlet as problem messages, extracts problem phrases by extracting a problem phrase from each one of the problem messages, and correlates a problem to a third party entity with the problem phrases.

The present disclosure relates generally to a method and apparatus for analyzing social media and, more particularly, to a method and apparatus for extracting business-centric information from social media.

### BACKGROUND

Social media has become very popular among users. Social media provides an outlet for users to provide insight into personal events in a real-time basis. Users can provide messages via the social media outlets ranging from political views to events that users are currently experiencing. Thus, social media may provide valuable information.

### SUMMARY

In one embodiment, the present disclosure teaches a method, non-transitory computer readable medium and apparatus for extracting business centric information from a social media outlet. In one embodiment, the method obtains a plurality of messages from a social media outlet, classifies a subset of the plurality of messages obtained from the social media outlet as problem messages, extracts problem phrases by extracting a problem phrase from each one of the problem messages, and correlates a problem to a third party entity with the problem phrases.

### BRIEF DESCRIPTION OF THE DRAWINGS

The teaching of the present disclosure can be readily understood by considering the following detailed description in conjunction with the accompanying drawings, in which:

FIG. 1 illustrates one example of a communications network;

FIG. 2 illustrates a block diagram of one embodiment of a machine learning tool;

FIG. 3 illustrates an example flowchart for a method for extracting business centric information from social media; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, non-transitory computer readable medium and an apparatus for extracting business centric information from social media outlets. For example, many social media outlets, e.g., websites such as, Facebook® of Palo Alto, Calif., Twitter® of San Francisco, Calif., and the like, allow users to post short messages about their current experiences or thoughts in real-time. In other words, the social media outlets allow users to post a short message about an experience as soon as it occurs. It should be noted that websites are only one form of social media outlets and the present disclosure is not limited to this one type of social media outlets. For example, other social media outlets may include broadly an application server, e.g., a mail server storing a plurality of messages and the like.

This business centric information may be very valuable to companies if the messages are about the performance or quality of a company's service or product. For example, when a user experiences an inability to access a data network provided by a network service provider, the user may be upset and immediately post a short message on a social media website stating “company XYZ's service is out again!” or “I hate when company XYZ's network goes down!” A company could use such short messages from the social media outlets to detect possible problems with the company's service or product immediately even before it is detected within the company. In other words, the company will be able to detect such problems well in advance before the problems are actually reported by the customers, who may be more inclined to complain about the problems to their peers before reporting the problems to the company that is providing the service or product.

In one embodiment, a problem may be broadly defined as a service or product that is not meeting the performance expectation of the customers. For example, a potential problem may occur when a service provided by a network service provider fails to meet an expected level of performance. In other words, a problem is related to a technical issue that may cause a lack of service or a degraded level of service. For example, the problem may be related to a slow service or a lack of service across a network due to a failure of a border element, a router or an application server or the problem may be related to performance of some hardware or device due to a lack of connection to the network or an incorrect configuration of software. A problem associated with a product may be a feature of the product is not functioning or the product is not working at all.

In other words, a problem is not related to an opinion, a sentiment or a general statement. Thus, embodiments of the present disclosure are related to using messages from the social media websites that are classified as problem messages that are related to a service associated with a specific company or entity. In another embodiment, the present disclosure are related to using messages from the social media websites that are classified as problem messages that are related to a product associated with a specific company or entity. In sum, a problem message is a message that identifies a technical issue with a product or a service and not related to a general sentiment (e.g., “1 like the product”, “I dislike the product”, “I like the features of a product”, “I like this product over that product”, and so on) that a user has with respect to a service or product.

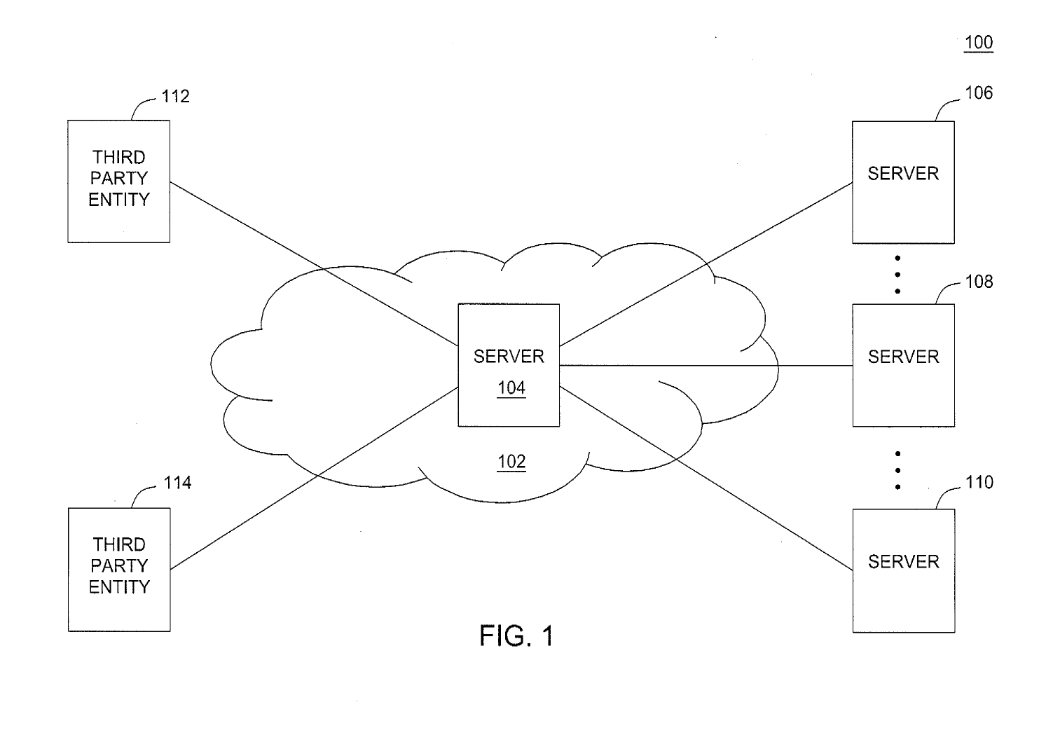

FIG. 1 is a block diagram depicting one illustrative example of a communications network 100. The communications network 100 may be any type of communications networks, e.g., an Internet protocol (IP) network such as an Internet Protocol (IP) Multimedia Subsystem (IMS) network, an asynchronous transfer mode (ATM) network, a long term evolution (LTE) network, a cellular network, a wireless network, and the like, related to the current disclosure. It should be noted that an IP network is broadly defined as a network that uses Internet Protocol to exchange data packets. Additional exemplary Internet protocol (IP) networks include Voice over Internet Protocol (VoIP) networks, Service over Internet Protocol (SoIP) networks, and the like.

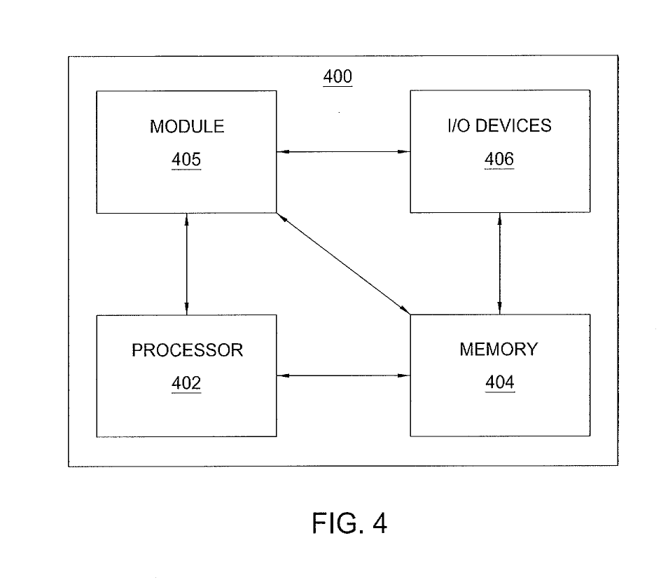

In one embodiment, the network 100 may comprise a core network 102 comprising one or more servers 104 (only one server is shown) for performing the methods described herein. The one or more servers 104 may include hardware of a general purpose computer as illustrated in FIG. 4 and discussed below. The one or more servers 104 may employ web crawlers to crawl the Internet or various communications networks to collect messages from various social media outlets, e.g., websites. For example, a web crawler is a type of software agent that can be programmed to visit a website to extract certain targeted information. In one embodiment, the one or more servers 104 may automatically crawl the internet on a periodic basis. For example, the service provider of the one or more servers 104 may set a time period of crawling to once every hour, once every day or once every week. In one embodiment, the one or more servers 104 may crawl the internet on a continuous basis. It should be noted that the network 100 may employ various network elements that are not shown, e.g., border elements, gateways, firewalls, edge routers, core routers, switches, media servers, call control elements, additional application servers, storage devices, and the like. Some of these network elements are in communication with the one or more servers 104 to support the crawling functions performed by the one or more servers 104. In addition, the one or more servers 104 may perform and implement the methods described herein.

In one embodiment, the one or more servers 104 may be in communication with one or more social media outlets or servers 106, 108 and 110. Although three social media outlets or servers are illustrated by example, it should be noted that the one or more servers 104 may be in communication with any number of social media outlets. The one or more social media outlets may be social media websites that allow users to post messages in real-time, such as for example, Facebook®, Twitter® and the like.

In one embodiment, the one or more servers 104 may also be in communication with one or more third party entities or companies 112 and 114. As a result, embodiments of the present disclosure may be provided as a paid service to the third party companies 112 and 114. For example, the third party companies 112 and 114 may pay the service provider of the core network 102 to monitor messages from the various social media outlets 106, 108 and 110 and classify problem messages associated with the respective third party companies 112 and 114. It should be noted that although only two third party companies 112 and 114 are illustrated by example, any number of third party companies may be included. Furthermore, the third party companies 112 and 114 may also employ various computing systems, e.g., application servers, to communicate with the one or more servers 104 operated by the service provider of network 102.

It should be noted that the social media outlets may be websites, as noted above, for providing a platform for spontaneous social interaction by or between registered users. Notably, in embodiments of the present disclosure, social media outlets do not include websites operated by the third party companies 112 and 114. In other words, embodiments of the present disclosure allow third party companies 112 and 114 to obtain and analyze messages left on social media outlets operated by other companies different from the third party companies 112 and 114. Said another way, the third party companies are not looking at their own internal websites or other media outlets operated by the third party companies themselves.

The above IP network is described to provide an illustrative environment in which packets for voice, video, data and/or multimedia services are transmitted on networks. In one embodiment, the current disclosure discloses a method and apparatus for extracting business centric information from social media outlets by using the illustrative network as shown in FIG. 1 and as described above. However, the present disclosure is not limited by the network architecture as shown in FIG. 1. Any network architecture that provides access to various social media outlets such that the present method and apparatus can be deployed is within the scope of the present disclosure.

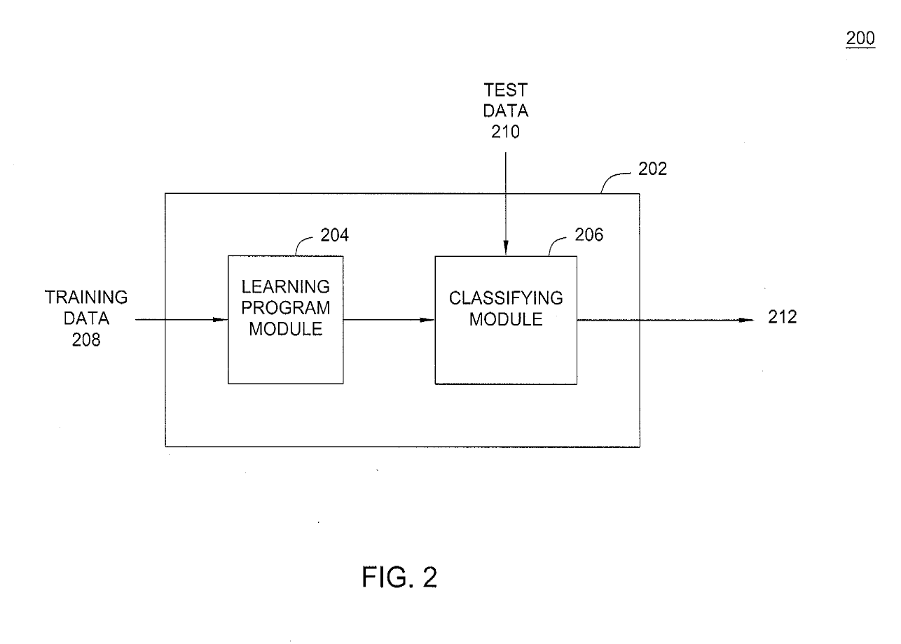

FIG. 2 illustrates a block diagram of a machine learning system or tool 202 that may be trained to classify a problem message and identify a problem phrase from the collected messages. In one embodiment, the machine learning system or tool 202 may be, for example, a maximum entropy classification model that is deployed in a hardware computing device, e.g., an application server. For example, the machine learning system or tool 202 may include hardware of a general purpose computer as illustrated in FIG. 4 and discussed below.

In one embodiment, the machine learning system or tool 202 comprises a learning program module 204 and a classifying module 206. In one embodiment, the learning program module 204 is provided with training data 208. For example, the training data 208 may include a list of messages with labels, where the labels (e.g., labels that indicate whether a message is a problem message or not, and so on) can be manually generated and classified by a human user. The training data 208 trains the learning program module 204 to learn various features of the messages or patterns such that it knows which messages are problem messages and can learn how to extract problem phrases.

In one embodiment, the training data 208 teaches the learning program module 204 to look for certain features in the messages to identify problem messages. For example, the features may include problem sentiment features (or broadly sentiment features) and problem syntactic features (or broadly syntactic features) and the like.

Users with problems often express sentiments either by negative emotions or by negative opinions. To capture these sentiments, in one embodiment the present disclosure may attempt to detect and extract the problem sentiment features. The problem sentiment features may include, for example, emoticon features, orthographic features, positive sentiment features and negative sentiment features. Emoticons may encompass, for example, binary features used to indicate presence or absence of happy, sad and angry emotions in the message (e.g., [symbol] , [symbol] and the like). It should be noted that there are various emoticons and the present disclosure is not limited to any particular types of emoticons.

Orthographic features may encompass binary features that are used to indicate the presence or absence of a token comprising of repeated punctuations, e.g., exclamation marks, question marks, periods or dollar signs in the message (e.g., “the Internet is not working!!!!!”, “what is going on????” and the like). A positive sentiment may encompass features that are used to indicate the presence or absence of phrases expressing positive sentiment in the message. In one embodiment, a dictionary may be used that is compiled over a period of time to collect phrases that are deemed to express a positive sentiment. A negative sentiment may be features that are used to indicate the presence or absence of phrases expressing a negative sentiment in the message. Again, a dictionary may be used that is compiled over a period of time to collect phrases that are deemed to express a negative sentiment.

Users may also describe a product or service problem using a specific syntactic pattern that can be recognized. In one embodiment, the problem syntactic features may include, for example, problem verbs, softer problem verbs, problem nouns and problem phrase patterns. For example, the problem verbs are used by users to describe a problem by explaining what is happening. The problem verbs may include “happening problem verbs” and “not happening problem verbs”. In one embodiment, “happening problem verbs” may include verbs specifically related to problems found in a service or product, e.g., a network service such as “fail”, “crash”, “overload”, “trip”, “fix”, “mess”, “break”, “overcharge”, “disrupt” and the like. In one embodiment, “not happening problem verbs” may include verbs specifically related to problems found in a network such as “work”, “function”, “connect”, “get”, “perform”, “receive”, “send”, “run”, “respond”, and the like. It should be noted that these verbs are only illustrative and should not be interpreted as a limitation of the present disclosure, i.e., other verbs can be used as well depending on the type of service or product.

In one embodiment, the softer problem verbs may include verbs that are used in other contexts outside of problems associated with a service or product, e.g., a network service. In other words, the softer problem verbs may be used in many different contexts and may not provide as strong of an indication as the problem verbs that the message is a problem message. For example, the softer problem verbs may include “die”, “drop”, “bite”, “trouble”, “foil”, and the like. Again, it should be noted that these verbs are only illustrative and should not be interpreted as a limitation of the present disclosure, i.e., other verbs can be used as well depending on the type of service or product.

In one embodiment, the problem nouns may include noun phrases with a specific head. For example, “we have an internet failure”, where “failure” is a head of the noun phrase. In another example, “we are having a 3 G outage”, where the head of the noun phrase would be “outage”. Other examples of problem nouns include “crash”, “issue”, “problem”, “trouble”, “breakdown”, “collapse”, “rupture” and the like. Again, it should be noted that these nouns are only illustrative and should not be interpreted as a limitation of the present disclosure, i.e., other nouns can be used as well depending on the type of service or product.

In addition, a number of common phrase patterns may be used to describe a problem. In one embodiment, the problem phrase patterns may include phrase patterns that include a verb and a particle (e.g., “screwed up”, “hang up”, “knock off”, “knocked out”, “acting up”, and the like). In another embodiment, the problem phrase patterns may include specific words used in problem phrase patterns that do not include a particle (e.g., act (“acting funky”) and behave (“the service is behaving weird today”). Again, it should be noted that these phrases are only illustrative and should not be interpreted as a limitation of the present disclosure, i.e., other phrases can be used as well depending on the type of service or product.

In one embodiment, the learning program module 204 is also trained to extract a problem phrase from a message once the message is identified as a problem message. In one embodiment, if the problem message contains a problem verb or a soft problem verb, the problem phrase may be assumed to be either the subject or object of the verb. In one embodiment, the subject may be selected as the problem phrase of the verb unless the subject is composed of a single pronoun, in which case the direct object is extracted as the problem phrase. For example, the problem message “my phone can't connect” has the verb “connect”. The subject of the verb “connect” is “my phone”. Thus, the problem phrase “my phone” is extracted from the problem message “my phone can't connect.” Extracting a subject or an object of a verb in a complex sentence requires attention to clausal complements and active or passive form of the sentence.

In one embodiment, if the problem message contains a problem noun, the problem phrase may be extracted by selecting the highest noun phrase in a parse tree with the problem noun. Said another way, if the problem phrase contains multiple problem nouns, the first problem noun would be extracted as the problem phrase. For example, the problem message “they are having bandwidth issues” would include the problem noun “bandwidth”. Also as the highest problem noun, the noun “bandwidth” would be extracted as the problem phrase.

In one embodiment, if the problem message contains a problem phrase pattern, the problem phrase may be extracted by selecting the subject or object of the problem phrase pattern. For example, if the problem phrase pattern is “the network is screwed up,” then the subject of the problem phrase pattern is “network”. Thus, the problem phrase “network” would be extracted.

However, there are some unique problem phrase patterns that are identified differently via syntactic patterns. For example, the terms “act” and “behave” do not have particle dependency and must be first identified using syntactic patterns. Once the phrase pattern is identified, the problem phrase can be extracted by selecting the subject or object of the problem phrase.

Another unique problem phrase pattern is encountered with the word “down”. Many times, the word “down” can be used in a phrase pattern that is used to describe a problem, e.g., “shut down,” “went down,” “are down” and the like. Although these phrase patterns are not specific to a problem description per se, if the message is classified as a problem message, then the phrase pattern including the word “down” is assumed to be describing a problem.

To isolate the problem phrase, in one embodiment the parse tree is searched for an adjective, adverb or particle phrase with a lexical head “down”. If the parent of this constituent is a verb phrase, the subject or the object of the lexical head verb is extracted as the problem phrase. If the parent of the constituent is a sentence, one can extract the noun phrase from the constituent list and extract it as the problem phrase.

After training the learning program module 204, the learning program module 204 may be loaded onto the classifying module 206. In one embodiment, the classifying module 206 may use the trained learning program module 204 to classify various messages as problem messages and to extract a problem phrase from the respective classified problem message in the test data 210. In one embodiment, the test data 210 is used to validate the training of the learning program module 204.

The machine learning system or tool 202 may provide an output 212 that indicates which messages among the test data 210 are classified as problem messages. In one embodiment, the output 212 may be a number between 0 and 1 which is an indication of a confidence of the classification of the problem message. In one embodiment, a predetermined value may be used as a threshold value (e.g., 0.5) to determine whether or not a message is a problem message. Once the machine learning system or tool 202 is adequately trained, the machine learning system or tool 202 may be loaded onto the one or more servers 104, illustrated in FIG. 1, to execute the methods described herein.

It should be noted that a high score for the validation of the machine learning tool 202 may not be necessary as the present disclosure takes advantage of redundancy. For example, three messages may be related to a connectivity issue in the network. In one example, the machine learning tool 202 may only identify one of the messages correctly as a problem message, which results in a 33% accuracy. Although the accuracy may be appear relatively low, the goal of detecting the connectivity issue is ultimately achieved by identifying at least one of the messages as a problem message.

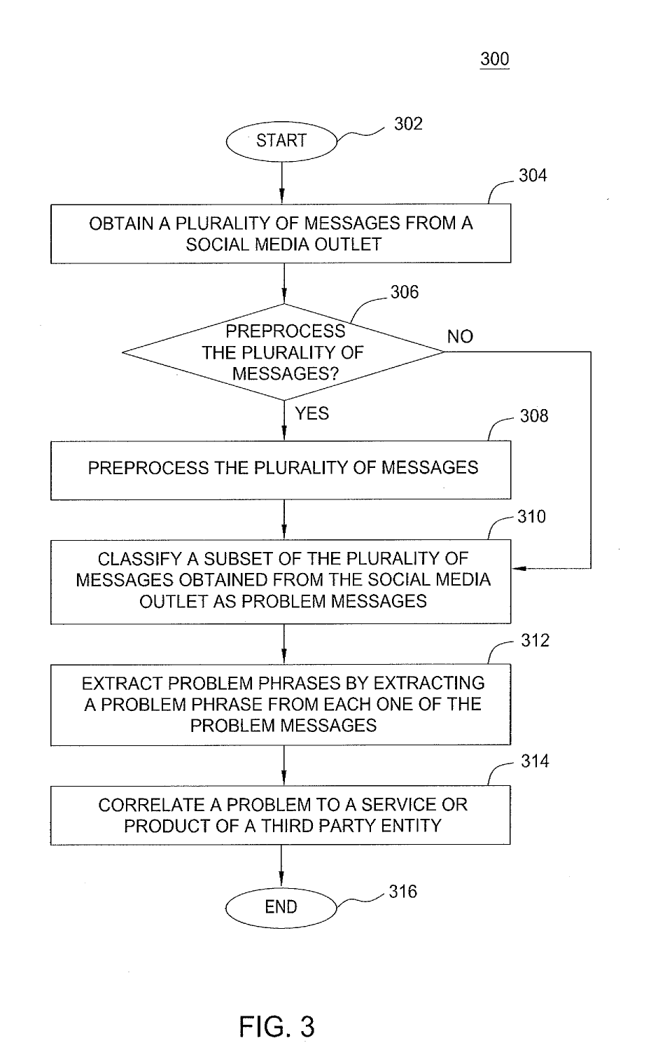

FIG. 3 illustrates a high level flowchart of a method 300 for extracting business centric information from a social media outlet, e.g., a website. In one embodiment, the method 300 is implemented by the one or more servers 104 or a general purpose computer having a processor, a memory and input/output devices as discussed below with reference to FIG. 4.

The method 300 begins at step 302 and proceeds to step 304. At step 304, the method 300 obtains a plurality of messages from a social media outlet, e.g., a social media website. The social media website may be various websites that allow a user to post real-time messages, such as for example, Twitter®, Facebook® and the like. In one embodiment, the messages may be relatively short messages or phrases such as Tweets® or status messages posted on Facebook®. It should be noted that these illustrative websites are only examples and should not be interpreted as a limitation of the present disclosure, i.e., any number of other social media outlets can be accessed. In one embodiment, the plurality of messages may be obtained from a plurality of different social media outlets.

In one embodiment, the messages may be obtained by the one or more servers 104. For example, the one or more servers 104 may automatically and periodically crawl the Internet to collect the messages from various social media websites. These social media websites can be publically available websites. However, in one embodiment, these social media websites may include private websites, if permissions are granted by the subscribers of the private websites.

In one embodiment, the plurality of messages may be filtered such that they are targeted or focused to a specific third party company, e.g., a third party company 112 or 114. As noted above, embodiments of the present disclosure can be provided on a subscription basis to the third party companies 112 and 114. For example, the third party company 112 could be named XYZ or has a product or service named ABC. Thus, the plurality of messages could be filtered to only examine those messages that include XYZ and/or ABC in the messages.

At step 306, the method 300 determines if the plurality of messages should be preprocessed. If the answer is no, the method 300 proceeds directly to step 310. If the answer is yes, the method 300 proceeds to step 308.

At step 308, the method 300 preprocesses the plurality of messages. In one embodiment, preprocessing may include filtering the plurality of messages to look for messages that are related to a particular company (e.g., a third party company 112 or 114). As noted above, the embodiments of the present disclosure may be provided as a paid service to other companies that are looking for real time feedback about their services or networks. For example, the plurality of messages may be filtered to only analyze those messages that contain “AT&T”. As a result, the final results of the analysis may be provided to “AT&T”.

In one embodiment, preprocessing may include preprocessing the messages to improve accuracy of the classification steps that will follow later in the method. In one embodiment, preprocessing the messages may include, by example, removing hashtags. For example, people may use the hashtag symbol # before relevant keywords in their Tweets to categorize those Tweets to show more easily in a Twitter Search. Preprocessing the messages may also include replacing abbreviated words with whole words (e.g., “sux”=sucks, “ur”=your, “tho”=though, and the like), expanding abbreviated phrases (e.g., “omg”=oh my god, “btw”=by the way, and the like), replacing multiple punctuation marks with a single punctuation mark, noting presence of emoticons and then removing them, and the like. These are only illustrative examples of various preprocessing steps that can be employed before the classification steps. Other preprocessing steps can be implemented as well in addition to these illustrative examples.

At step 310, the method 300 classifies a subset of the plurality of messages obtained from the social media outlet as problem messages. For example, the various features as discussed above may be the focus of an analysis for each one of the plurality of messages. In one embodiment, the features may include problem sentiment features and problem syntactic features.

Users with problems often express sentiments either by negative emotions or by negative opinions. To capture these sentiments, the present disclosure may look at the problem sentiment features. The problem sentiment features may include, for example, emoticon features, orthographic features, positive sentiment features and negative sentiment features. Emoticons may be for example binary features used to indicate presence or absence of happy, sad and angry emotions in the message (e.g., [symbol] , [symbol] and the like). Orthographic features may be binary features that are used to indicate the presence or absence of a token consisting of repeated exclamation marks, question marks, periods or dollar signs in the message (e.g., “the Internet is not working!!!!!”, “what is going on????” and the like). A positive sentiment may be features that are used to indicate the presence or absence of phrases expressing positive sentiment in the message. A negative sentiment may be features that are used to indicate the presence or absence of phrases expressing negative sentiment in the message.

Users may also describe a product or service problem using a specific syntactic pattern that can be recognized by the trained machine learning system or tool 202. In one embodiment, the problem syntactic features may include, for example, problem verbs, softer problem verbs, problem nouns and problem phrase patterns. The problem verbs are used by users to describe a problem by explaining what is happening. The problem verbs may include “happening problem verbs” and “not happening problem verbs”. In one embodiment, “happening problem verbs” may include verbs specifically related to problems found in a particular service or product, e.g., a network service such as “fail”, “crash”, “overload”, “trip”, “fix”, “mess”, “break”, “overcharge”, “disrupt” and the like. In one embodiment, “not happening problem verbs” may include verbs specifically related to problems found in a particular service or product such as “work”, “function”, “connect”, “get”, “perform”, “receive”, “send”, “run”, “respond”, and the like.

In one embodiment, the softer problem verbs may include verbs that are used in other contexts outside of problems associated with a network. In other words, the softer problem verbs may be used in many different contexts and may not provide as strong of an indication as the problem verbs that the message is a problem message. For example, the softer problem verbs may include: “die”, “drop”, “bite”, “trouble”, “foil”, and the like.

In one embodiment, the problem nouns may include noun phrases with a specific head. For example, “we have an internet failure” where “failure” is a head of the noun phrase. In another example, “we are having a 3 G outage” the head of the noun phrase would be “outage”. Other examples of problem nouns include: “crash”, “issue”, “problem”, “trouble”, and the like.

In addition, a number of common phrase patterns may be used to describe a problem. In one embodiment, the problem phrase patterns may include phrase patterns that include a verb and a particle (e.g., “screwed up”, “hang up”, “knock off”, “knocked out”, “acting up”, and the like). In another embodiment, the problem phrase patterns may include specific words used in problem phrase patterns that do not include a particle (e.g., act (“acting funky”) and behave (“the service is behaving weird today”).

In one embodiment, the trained machine learning system or tool 202 may analyze one or more of the problem sentiment features and the problem syntactic features to determine if a message is a problem message. For example, each one of the features may be assigned value or a weight. The trained machine learning system or tool 202 may then determine if a message is a problem message by summing a value of all of the features that are detected in the message and comparing the value to a predefined threshold (e.g., 50%). If the value is greater than the predefined threshold, then the trained machine learning system or tool 202 may determine that the message is a problem message. It should be noted that the predefined threshold can be dynamically and selectively set in accordance with a particular service or product. For example, the output of the classifier can be analyzed to determine whether the predefined threshold should be adjusted to improve the accuracy of the classifier over time.

At step 312, the method 300 extracts problem phrases by extracting a problem phrase from each one of the problem messages. In other words, once the subset of the plurality of messages is classified as problem messages, each one of the problem messages may be examined to extract a problem phrase. After each problem message of the problem messages is examined, a collection of problem phrases may be extracted. For example, the trained machine learning system or tool 202 may extract the problem phrase from each problem message by exploiting the syntactic patterns discussed above.

In one embodiment, if the problem message contains a problem verb or a soft problem verb, the problem phrase may be assumed to be either the subject or object of the verb. In one embodiment, the subject may be selected as the problem phrase of the verb unless the subject is composed of a single pronoun, in which case the direct object is extracted as the problem phrase. For example, the problem message “my phone can't connect” has the verb “connect”. The subject of the verb “connect” is “my phone”. Thus, the problem phrase “my phone” is extracted from the problem message “my phone can't connect.” Extracting a subject or an object of a verb in a complex sentence requires attention to clausal complements and active or passive form of the sentence.

In one embodiment, if the problem message contains a problem noun, the problem phrase may be extracted by selecting the highest noun phrase in a parse tree with the problem noun. Said another way, if the problem phrase contains multiple problem nouns, the first problem noun would be extracted as the problem phrase. For example, the problem message “they are having bandwidth issues” would include the problem noun “bandwidth”. Also as the highest problem noun, the noun “bandwidth” would be extracted as the problem phrase.

In one embodiment, if the problem message contains a problem phrase pattern, the problem phrase may be extracted by selecting the subject or object of the problem phrase pattern. For example, if the problem phrase pattern is “the network is screwed up,” then the subject of the problem phrase pattern is “network”. Thus, the problem phrase “network” would be extracted.

However, there are some unique problem phrase patterns that are identified differently via syntactic patterns. For example, the phrase “act” and “behave” do not have particle dependency and must be first identified using syntactic patterns. Once the phrase pattern is identified, the problem phrase can be extracted by selecting the subject or object of the problem phrase.

Another unique problem phrase pattern is encountered with the word “down”. Many times, the word “down” can be used in a phrase pattern that is used to describe a problem, e.g., “shut down,” “went down,” “are down” and the like. Although these phrase patterns are not specific to a problem description per se, if the message is classified as a problem message, then the phrase pattern including the word “down” is assumed to be describing a problem.

To isolate the problem phrase, the parse tree is searched for an adjective, adverb or particle phrase with a lexical head “down”. If the parent of this constituent is a verb phrase, the subject or the object of the lexical head verb is extracted as the problem phrase. If the parent of the constituent is a sentence, the method can extract the noun phrase from the constituent list and extract it as the problem phrase.

At step 314, the method 300 correlates a problem to a service or a product of a third party entity (e.g., a third party company 112 or 114), with the problem phrases. For example, if the problem phrase “bandwidth” was extracted from one or more of the problem messages, a correlation may be made between “bandwidth” and one of various possible network problems associated with a network service provider. For example, a check may be made to see if a router has failed or if there is an unusual volume on a particular link, trunk or node. As a result, the messages collected from the social media websites may be used to quickly identify possible problems of a service provider's network in real-time.

In one embodiment, a different problem may be correlated with each one of the problem phrases that are extracted. For example, each problem phrase may be related to a different problem. In other words, some of the problem phrases may be related to a router down in a first location and other problem phrases may be related to a server down at a second location and the like.

Once a problem has been identified from the correlation, a notification can be sent to the third party entity to indicate that there is a potential problem. In one embodiment, the correlation may further involve a threshold for each problem. Namely, the third party entity may set a threshold where at least 100 messages having the same problem phrases must be detected first before it is deemed to be a problem. There may also be a temporal parameter as well, e.g., 100 messages within a fixed period of time (e.g., within a hour, a day and so on) or a sliding window of time (every hour). This additional threshold will minimize the sensitivity of the classifier to a very small amount of problem messages which may indicate a general opinion of a small group of customers or a short term problem that may likely resolve itself over time. This threshold can be dynamically and selectively adjusted as necessary, e.g., by the third party entity or the service provider providing the service to the third party entity.

It should be noted that although not explicitly specified, one or more steps of the method 300 described above may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step.

FIG. 4 depicts a high-level block diagram of a general-purpose computer (broadly a hardware device) suitable for use in performing the functions described herein. As depicted in FIG. 4, the system 400 comprises a processor element 402 (e.g., a CPU), a memory 404, e.g., random access memory (RAM) and/or read only memory (ROM), a module 405 for extracting business centric information from social media outlets, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents. In one embodiment, the present module or process 405 for extracting business centric information from social media outlet can be loaded into memory 404 and executed by processor 402 to implement the functions as discussed above. As such, the present method 405 extracting business centric information from social media outlet (including associated data structures) of the present disclosure can be stored on a non-transitory (e.g., physical and tangible) computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for extracting business centric information from a social media outlet, comprising:
obtaining a plurality of messages from a social media outlet;
classifying a subset of the plurality of messages obtained from the social media outlet as problem messages;
extracting problem phrases by extracting a problem phrase from each one of the problem messages; and
correlating a problem to a third party entity with the problem phrases.

2. The method of claim 1, further comprising:
preprocessing the plurality of messages before the classifying of the subset of the plurality of messages as problem messages.

3. The method of claim 2, wherein the preprocessing comprises:
removing a hashtag in the plurality of messages.

4. The method of claim 2, wherein the preprocessing comprises:
replacing an abbreviation in the plurality of messages.

5. The method of claim 2, wherein the preprocessing comprises:
expanding a term in the plurality of messages.

6. The method of claim 2, wherein the preprocessing comprises:
removing multiple punctuations in the plurality of messages.

7. The method of claim 2, wherein the preprocessing comprises:
removing an emoticon in the plurality of messages.

8. The method of claim 1, wherein the classifying comprises identifying the subset of the plurality of messages based upon a sentiment feature.

9. The method of claim 8, wherein the sentiment feature comprises an emoticon feature.

10. The method of claim 8, wherein the sentiment feature comprises an orthographic feature.

11. The method of claim 8, wherein the sentiment feature comprises a positive sentiment feature.

12. The method of claim 8, wherein the sentiment feature comprises a negative sentiment feature.

13. The method of claim 8, wherein the classifying further comprises identifying the subset of the plurality of messages based upon a problem syntactic feature.

14. The method of claim 1, wherein the classifying comprises identifying the subset of the plurality of messages based upon a problem syntactic feature.

15. The method of claim 14, wherein the problem syntactic feature comprises a problem verb.

16. The method of claim 14, wherein the problem syntactic feature comprises a problem noun.

17. The method of claim 14, wherein the problem syntactic feature comprises a problem phrase pattern.

18. The method of claim 17, wherein the extracting the problem phrase from each one of the problem messages comprises identifying the problem phrase based upon the problem phrase pattern.

19. A non-transitory computer-readable medium having stored thereon a plurality of instructions, the plurality of instructions including instructions which, when executed by a processor, cause the processor to perform a method for extracting business centric information from a social media outlet, comprising:
obtaining a plurality of messages from a social media outlet;
classifying a subset of the plurality of messages obtained from the social media outlet as problem messages;
extracting problem phrases by extracting a problem phrase from each one of the problem messages; and
correlating a problem to a third party entity with the problem phrases.

20. An apparatus for extracting business centric information from a social media outlet, comprising:
a processor configured to:
obtain a plurality of messages from a social media outlet;
classify a subset of the plurality of messages obtained from the social media outlet as problem messages;
extract problem phrases by extracting a problem phrase from each one of the problem messages; and
correlate a problem to a third party entity with the problem phrases.
